(19) United States
(12) Patent Application Publication
(10) Pub. No.: US 2004/0103154 A1
(43) Pub. Date: May 27, 2004

(54) Method and apparatus in a data processing system for creating a distribution list for an e-mail message

(75) Inventors: Bhargav V. Perepa, Austin, TX (US); Sujatha Perepa, Austin, TX (US); Vishwanath Venkataramappa, Austin, TX (US)

Correspondence Address: DUKE W. YEE, CARSTENS, YEE & CAHOON, L.L.P., P.O. BOX 802334, DALLAS, TX, 75380, US

(73) Assignee: International Business Machines Corporation, Armonk, NY

(21) Appl. No.: 10/303,408

(22) Filed: Nov. 23, 2002

(51) Int. Cl. G06F 15/16

(52) U.S. Cl. 709/206

(57) ABSTRACT

A method, apparatus, and computer instructions for processing an e-mail message. A determination is made as to whether a number of addresses in the e-mail message exceed a threshold. A distribution list is created from the number of addresses if the number of addresses in the e-mail message exceeds the threshold.

### CROSS REFERENCE TO RELATED APPLICATION

The present invention is related to the following application entitled: “Method and Apparatus for Handling Client Mail Message Header Fields”, Ser. No. ______, attorney docket no. AUS920020661US1; filed even date hereof, assigned to the same assignee, and incorporated herein by reference.

### BACKGROUND OF THE INVENTION

1. Technical Field

The present invention relates generally to an improved data processing system, and in particular, to a method and apparatus for processing e-mail messages. Still more particularly, the present invention provides a method and apparatus for handling addresses in header fields of e-mail messages.

2. Description of Related Art

The Internet, also referred to as an “internetwork”, is a set of computer networks, possibly dissimilar, joined together by means of gateways that handle data transfer and the conversion of messages from the sending network to the protocols used by the receiving network (with packets if necessary). When capitalized, the term “Internet” refers to the collection of networks and gateways that use the Transmission Control Protocol/Internet Protocol (TCP/IP) suite of protocols.

The Internet has become a cultural fixture as a source of information, entertainment, and communications. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies which must interact with virtually all segments of society such as the Internal Revenue Service and secretaries of state. Further, the Internet is a popular medium for commercial transactions.

In addition to being a source of information, the Internet also provides a communications medium. The Internet has become the most popular computer network used by consumers and businesses to send and receive electronic mail, also referred to as “e-mail”. The Internet allows users to readily send and receive e-mail to and from computers around the world. Each user typically has a unique Internet e-mail address (e.g., steve@ibm.com). A user with an e-mail account and a computer capable of connecting to the Internet can easily send and receive e-mail over the network.

E-mail allows a person to quickly and easily send textual messages and other information, such as, for example, pictures, sound recordings, and formatted documents electronically to other e-mail users anywhere in the world. An e-mail user will typically create a message using an e-mail program running on a computer connected to a computer network through a modem. The message will include an e-mail “address” for the intended recipient. When the user has finished entering the message, the user may “send” the message to the intended recipient. The e-mail program then electronically transmits the message over the computer network. The recipient, using an e-mail program running on the recipient's computer, can then “receive” the message.

Many e-mail/groupware client programs display the lists in message header content fields, such as, From:, To:, Resent-To:, cc:, Resent-cc:, bcc:, Resent-bcc:. These message header fields may include many mailbox addresses. Some output presentation technologies using e-mail/groupware clients do a reasonable job of displaying these multiple addresses as drop-down, scrollable list boxes. However, these programs perform poorly when converting e-mail messages with a long list of addresses in message header fields to other forms of output devices, such as printers, fax machines, text to other form translations, and screen reader outputs.

For example, a client e-mail program sending a message to a printer or fax machine may cause printing of many pages of address fields followed by only a few lines of important subject and text body content. This problem manifests in a similar and related fashion when the output technologies take the form of screen readers or other translations from text form. With the emergence of pervasive computing enabled by interdisciplinary, multi-faceted technology via text and multimedia documents, the presentation of these addresses distracts and generates frustration in presenting e-mail messages in pervasive devices, such as personal digital assistants (PDAs), electronic books, user sensitive devices, set top boxes, game consoles, digital phones, and a host of technologies/devices that are capable of exchanging messages and e-mails. Presently available programs do not offer any methods to alleviate this output conversion wastage. Therefore, it would be advantageous to have an improved method, apparatus, and computer instructions for handling addresses in e-mail message header fields.

### SUMMARY OF THE INVENTION

The present invention provides a method, apparatus, and computer instructions for processing an e-mail message. A determination is made as to whether a number of addresses in the e-mail message exceed a threshold. A distribution list is created from the number of addresses if the number of addresses in the e-mail message exceeds the threshold.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a distributed data processing system in which the present invention may be implemented;

FIG. 2 is a block diagram illustrating a data processing system in which the present invention may be implemented;

FIG. 3 is a block diagram of a custom messaging system in which a message handling process of the present invention may be used in accordance with a preferred embodiment of the present invention;

FIG. 4 is a block diagram of components used in processing messages in accordance with the preferred embodiment of the present invention;

FIGS. 5A and 5B are diagrams illustrating messages in accordance with a preferred embodiment of the present invention;

FIG. 6 is a diagram illustrating a user interface for setting threshold values in accordance with a preferred embodiment of the present invention;

FIG. 7 is a flowchart of a process used for setting thresholds for addresses in message header fields in accordance with a preferred embodiment of the present invention;

FIG. 8 is a flowchart of a process used for processing a message in a mail client in accordance with a preferred embodiment of the present invention; and

FIG. 9 is a flowchart of a process used for outputting a message in accordance with a preferred embodiment of the present invention.

### DETAILED DESCRIPTION OF THE PREFERRED EMBODIMENT

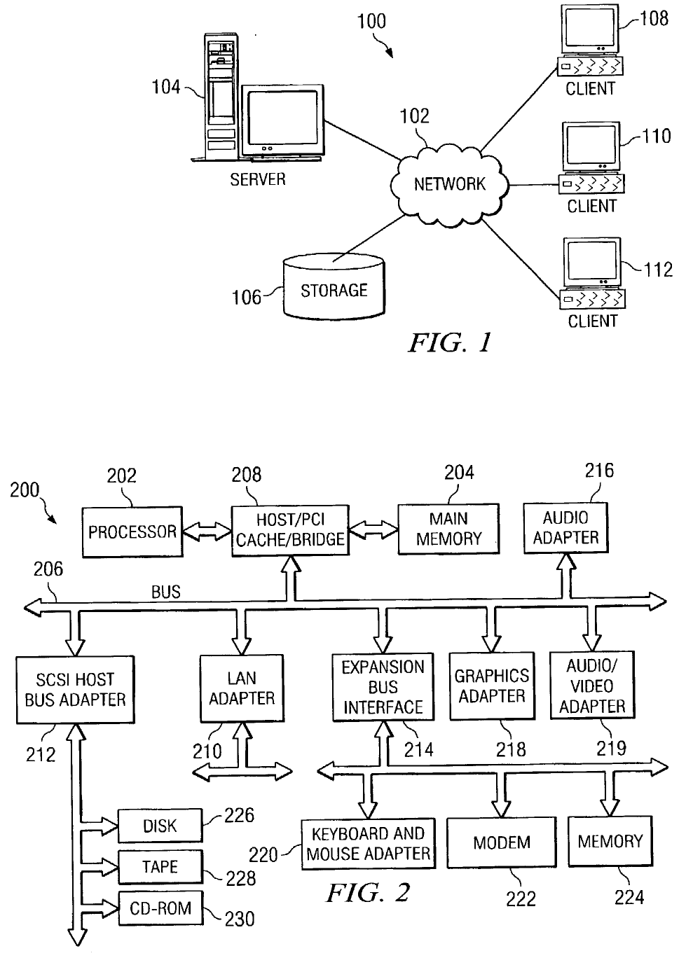

With reference now to the figures, FIG. 1 depicts a pictorial representation of a distributed data processing system in which the present invention may be implemented. Distributed data processing system 100 is a network of computers in which the present invention may be implemented. Distributed data processing system 100 contains a network 102, which is the medium used to provide communications links between various devices and computers connected together within distributed data processing system 100. Network 102 may include permanent connections, such as wire or fiber optic cables, or temporary connections made through telephone connections.

In the depicted example, server 104 is connected to network 102 along with storage unit 106. In addition, clients 108, 110, and 112 also are connected to a network 102. These clients 108, 110, and 112 may be, for example, personal computers or network computers. For purposes of this application, a network computer is any computer, coupled to a network, which receives a program or other application from another computer coupled to the network. In the depicted example, server 104 provides data, such as boot files, operating system images, and applications to clients 108-112. Clients 108, 110, and 112 are clients to server 104. In the depicted examples, server 104 may contain an electronic mail system from which clients 108, 110, and 112 send and receive e-mail messages.

Distributed data processing system 100 may include additional servers, clients, and other devices not shown. For example, messages may be sent and received between server 104 and other servers (not shown) to distribute and receive messages from other clients (not shown). Of course, distributed data processing system 100 may include other types of clients other than a computer. Other types of clients which may receive and exchange e-mail messages include, for example without limitation, a PDA, a digital phone, a game console, a digital video recorder, and an electronic book device.

In the depicted example, distributed data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, distributed data processing system 100 also may be implemented as a number of different types of networks, such as for example, an intranet, a local area network (LAN), or a wide area network (WAN). FIG. 1 is intended as an example, and not as an architectural limitation for the present invention.

Turning now to FIG. 2, a block diagram illustrating a data processing system is shown in which the present invention may be implemented. Data processing system 200 is an example of a client computer. Data processing system 200 employs a peripheral component interconnect (PCI) local bus architecture. Although the depicted example employs a PCI bus, other bus architectures such as Micro Channel and ISA may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards. In the depicted example, local area network (LAN) adapter 210, SCSI host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230.

An operating system runs on processor 202 and is used to coordinate and provide control of various components within data processing system 200 in FIG. 2. The operating system may be a commercially available operating system such as OS/2, which is available from International Business Machines Corporation. “OS/2” is a trademark of International Business Machines Corporation. Instructions for the operating system and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash read-only memory (ROM), equivalent nonvolatile memory, or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM drive 230. In that case, the computer, to be properly called a client computer, must include some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be any device featuring some kind of browser and capable of receiving e-mail messages, such as a PDA, a digital phone, digital/satellite TVs, wireless devices, set top boxes, MP3 players, wearable devices such as wrist watches, e-books, pagers, and game consoles.

The depicted example in FIG. 2 and above-described examples are not meant to imply architectural limitations.

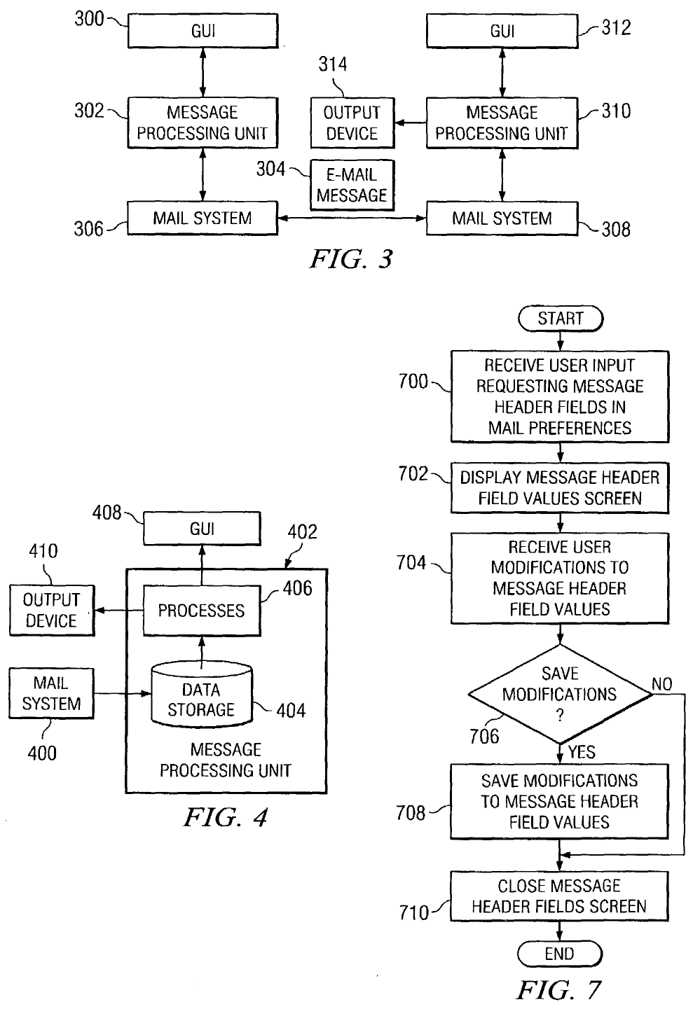

With reference now to FIG. 3, a block diagram of a custom messaging system in which a message handling process of the present invention may be used is depicted in accordance with a preferred embodiment of the present invention. In this example, a graphical user interface (GUI) 300 is used in combination with a message processing unit 302 to send an electronic message, such as e-mail message 304. In this example, e-mail message 304 is an e-mail message that is sent through mail system 306 to mail system 308 for receipt by message processing unit 310, which selectively provides a display of the message in a message list within GUI 312.

In accordance with a preferred embodiment of the present invention, message processing unit 310 includes a process for managing addresses in message header fields for presentation within GUI 312 or for output to output device 314 based on the number of addresses in the message header fields. Specifically, e-mail messages having addresses in message header fields exceeding a threshold may be abbreviated for output to GUT 312 or output device 314.

In this manner, messages having hundreds or thousands of addresses may be presented for output without a user having to waste resources for the presentation of these addresses when the user is only concerned with the subject and body of the message.

In abbreviating the addresses, a distribution list may be generated. Further, this distribution list could be generated at either the sending or receiving message processing unit depending on the particular implementation. This distribution list may be retreived through a selected user input, such as the selection of an icon associated with the distribution list.

In this example, GUI 300, message processing unit 302, and mail system 306 may be located at one client while GUI 312, message processing unit 310, and mail system 308 are located at another client in a distributed data processing system. In these examples, mail system 306 and mail system 308 are legacy mail systems while GUI 300, message processing unit 302, GUI 312, and message processing unit 310 implement processes of the present invention. These clients may be implemented using a data processing system, such as data processing system 200 in FIG. 2. Message processing unit 302 and message processing unit 310 process e-mail messages created and received by the user through presently available or legacy mail system processes found in mail system 306 and mail system 308. The legacy mail systems may be implemented using currently available mail systems, such as Lotus Notes or CC Mail, which are available from Lotus Development Corporation. Other mail systems, which may be used, include, for example, Microsoft Outlook and Yahoo Mail Client. Microsoft Outlook is available from Microsoft Corporation and Yahoo Mail Client is available from Yahoo! Inc.

The actual storage and transmission of e-mail, including customized content, is implemented using conventional e-mail data formats and protocols. The separation of these functions is shown for purposes of clearly illustrating the present invention. Of course, depending on the implementation, the processes of the present invention may be implemented directly within a mail system.

Turning now to FIG. 4, a block diagram of components used in processing messages is depicted in accordance with the preferred embodiment of the present invention. In this example, mail system 400 receives messages. Message processing unit 402 periodically retrieves e-mail messages from the mail system 400 for storage within data storage 404. The messages are processed by processes 406 to determine whether the addresses in a message should be abbreviated. Specifically, processes 406 parse and examine an e-mail message received from mail system 400 to determine whether a threshold is exceeded by addresses within message header fields. A different threshold may be set for each message header field in these illustrations. Processes 406 abbreviate the list in a manner to enable the user to access the complete list if the user wishes to examine the entire list of addresses.

In this manner, an e-mail message may be presented to a user through GUI 408 or output device 410 without wasting resources or requiring the user to view large numbers of addresses before viewing the subject and body of the message. Output device 410 may take many forms, such as, for example, a facsimile machine, a projector, a printer, or an audio system for text to speech conversion. Further, the output also may be presented on GUI 408, which is displayed in a display device.

In abbreviating the output, the addresses in message header fields exceeding the threshold are abbreviated. This abbreviation may be performed by replacing the addresses that are normally presented in an address header field with an abbreviated format, such as, for example, a subset of the addresses or an icon or some other graphical indicator. With this abbreviated format, presentation of the message in output device 410 or GUI 408 may be performed without wasting resources or inconvenience to the user.

As part of the abbreviation process, the addresses may be placed in a distribution list or some other type of file. In the instance in which the addresses in a message header field are abbreviated through the use of a graphical indicator, such as an icon, the distribution list may be linked to the graphical indicator to allow the user to access the entire list if such access is desired. Further, this distribution list also may be generated by the sender of a message. In this instance, the distribution list may be attached to the message as an attachment in the form of a text file.

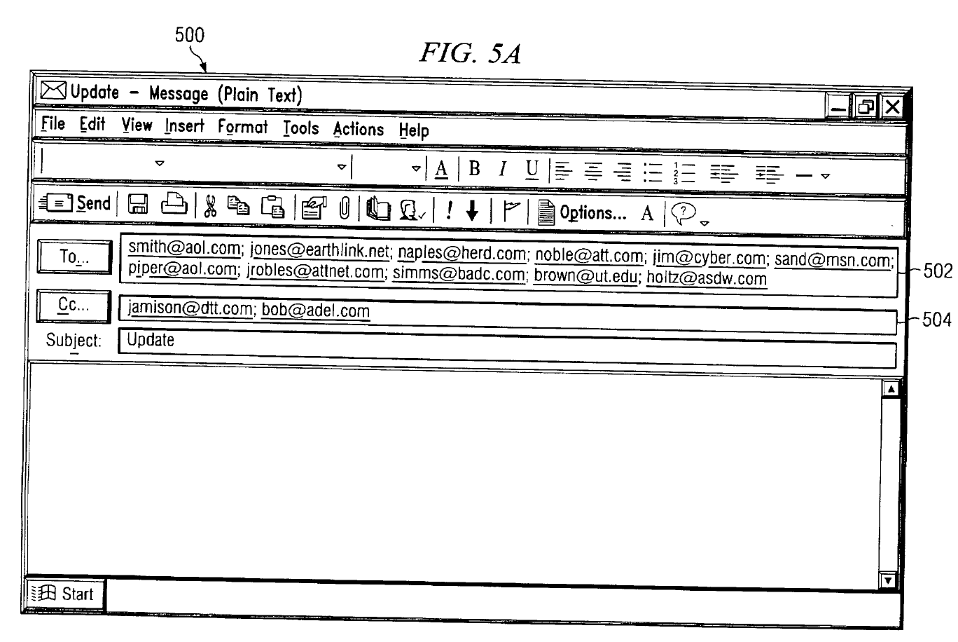

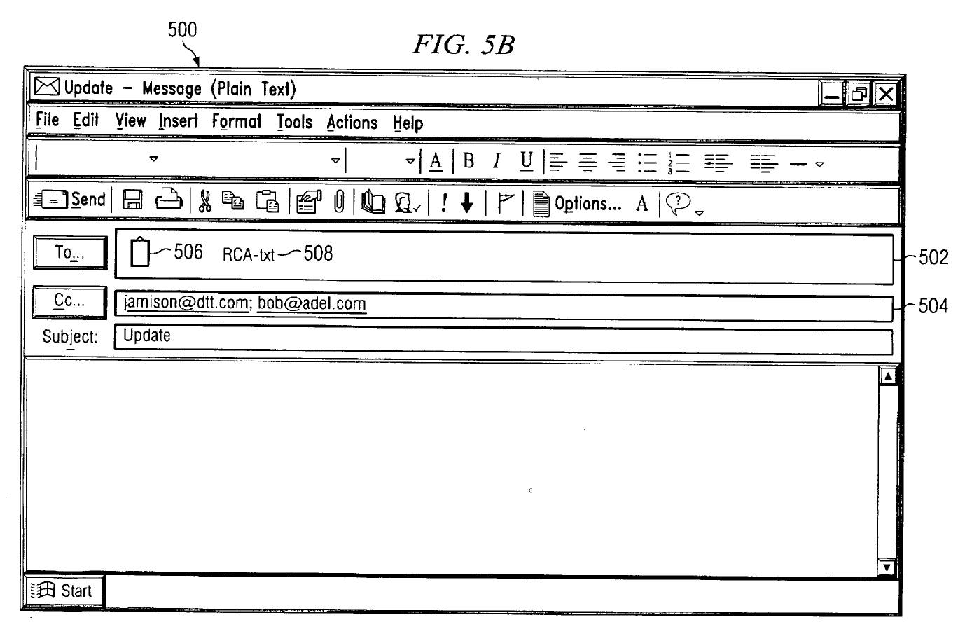

With reference now to FIGS. 5A and 5B, diagrams illustrating messages are depicted in accordance with a preferred embodiment of the present invention. These messages are examples of messages that may be processed by message processing unit 402 in FIG. 4.

In FIG. 5A, e-mail message 500 contains eleven addresses in message header field 502. Two addresses are present in message header field 504. If, for example, a threshold is set for five addresses for each of the message header fields, then message header field 502 would be abbreviated as illustrated in FIG. 5B. Message header field 504 remains in the unabbreviated form as can be seen in FIG. 5B. In this example, the addresses in message header field 502 are replaced with a graphical indicator in the form of icon 506 and filename 508.

The addresses in message header field 502 are saved in a file, which is referred to as a distribution list in these examples. The addresses in this distribution list may be accessed through the selection of icon 506. By selecting icon 506, e-mail message 500 is presented with the addresses as illustrated in message header field 502 in FIG. 5A. After viewing the addresses, the user may collapse those addresses back into the form illustrated in message header field 502 in FIG. 5B.

It is desirable to send the message to an output device in the form illustrated in FIG. 5B to save resources, such as, for example, paper in a printer. Such resource saving is especially important in the instance in which the number of addresses in the different message header fields would result in the printing of many pages of text when the actual subject and body of the message only require a few lines.

Further, if the addresses are abbreviated by the sender of the message, the distribution list may be sent as an attachment to the message.

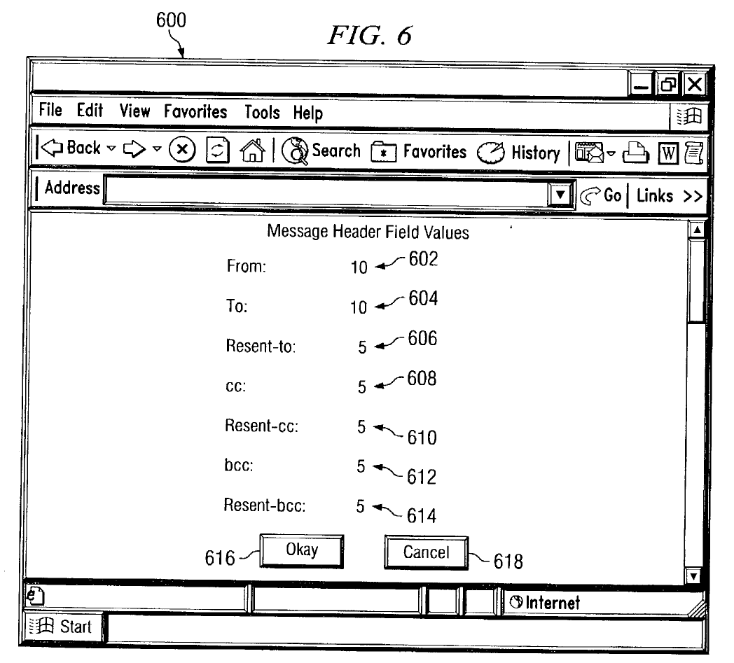

Turning now to FIG. 6, a diagram illustrating a user interface for setting threshold values is depicted in accordance with a preferred embodiment of the present invention. In this example, window 600 is an example of a user interface that may be presented by processes 406 in FIG. 4 to receive input for thresholds for different message header fields. A user may select values for message header fields 602, 604, 606, 608, 610, 612, and 614. This interface allows a user to set different values for different message header fields. In these examples, message header fields 602 and 604 have been set to ten addresses, while message header fields 606, 608, 610, 612, and 614 have been set to a threshold of five addresses.

Selection of okay button 616 results in these values being saved and being used as thresholds for determining when to abbreviate addresses in message header fields. Selection of cancel button 618 results in no changes to the thresholds.

With reference now to FIG. 7, a flowchart of a process used for setting thresholds for addresses in message header fields is depicted in accordance with a preferred embodiment of the present invention. The process illustrated in FIG. 7 may be implemented in a e-mail message program, such as message processing unit 402 in FIG. 4.

The process begins by receiving user input requesting message header fields in mail preferences (step 700). The message header field values screen is displayed (step 702). This screen may be implemented using window 600 in FIG. 6 above. The user modifications to the message header field values are received (step 704). Next, a determination is made as to whether the modifications should be saved (step 706). If the modifications are to be saved, the values entered or modified by the user in the message header fields value screen are saved (step 708). Thereafter, the message header fields screen is closed (step 710) and the process terminates thereafter. With reference again to step 706, if the modifications are not be to saved, the process proceeds to step 710 as described above.

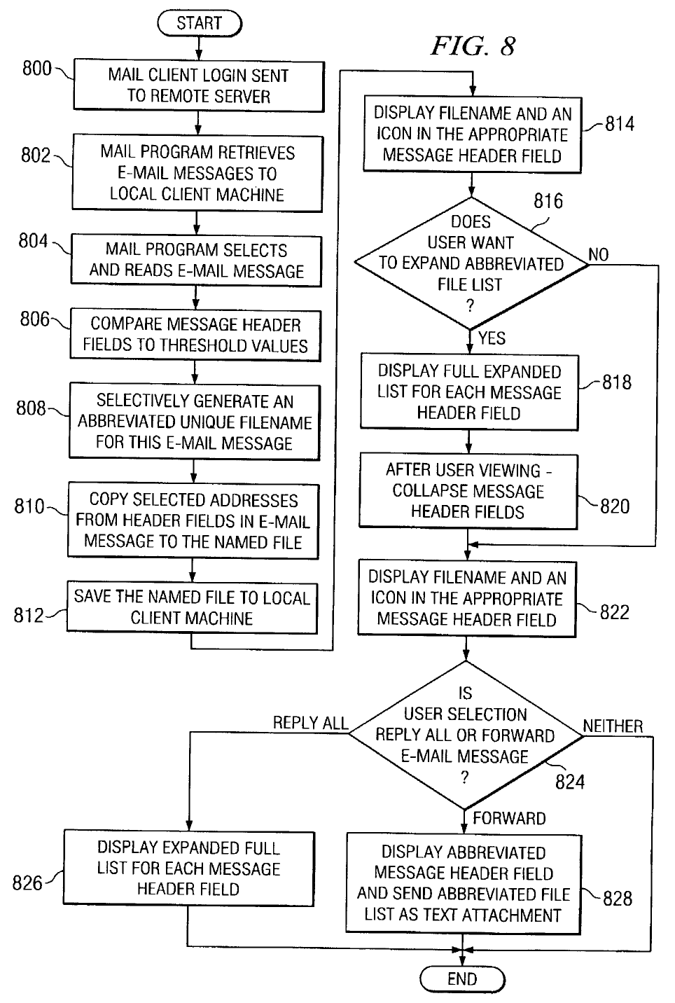

Turning now to FIG. 8, a flowchart of a process used for processing a message in a mail client is depicted in accordance with a preferred embodiment of the present invention. The process illustrated in FIG. 8 may be implemented in an e-mail program, such as message processing unit 402 in FIG. 4. The process illustrated in FIG. 8 more specifically depicts the receiving of messages and forwarding of a message or a reply to a message.

The process begins by sending the client login to the remote server (step 800). This server may be mail system 400 in FIG. 4 and may take the form of a POP3 server. The e-mail messages are retrieved by the e-mail program and saved to the local client machine (step 802). An unprocessed e-mail message is selected and read (step 804). The number of addresses in the message header fields are compared to the threshold values (step 806). These threshold values are values, such as those selected using window 600 in FIG. 6. An abbreviated unique filename for this message is selectively generated (step 808). A filename is generated only if the addresses exceed the threshold values set for the message header fields. When the addresses exceed these threshold values, these addresses are copied from the header fields in the e-mail message to the named file (step 810). The named file is saved to the local client machine (step 812). The addresses in this file form a distribution list in these examples. The filename and an icon are displayed in the appropriate e-mail message header field (step 814). The icon and filename may be displayed as illustrated in FIG. 5B above.

Next, a determination is made as to whether the user wants to expand the abbreviated file list (step 816). This determination may be made, for example, by identifying whether the user has selected the icon associated with the file. If the user does want to expand the abbreviated file list, the full expanded list is displayed for each message header field (step 818). After the user views the expanded fields, the message header fields are collapsed back into an abbreviated form (step 820). Step 820 may be initiated using different mechanisms. For example, the user may move a pointer off the message header field to cause the field to collapse or the user may choose a button or other control to collapse the field. The filename and an icon are displayed in the appropriate e-mail message header field (step 822).

A determination is made as to whether the user selection is “reply all” or “forward” e-mail message (step 824). If the selection is “reply all”, the expanded full list is displayed for each message header field (step 826) with the process terminating thereafter. If the selection is “forward”, the abbreviated message header field is displayed and the abbreviated file list is sent as a text attachment to the e-mail message (step 828) with the process terminating thereafter.

With reference again to step 824, if the user has performed neither of these actions, the process terminates. Returning to step 816, if the user does not want to expand the abbreviated file list, the process proceeds to step 822 described above.

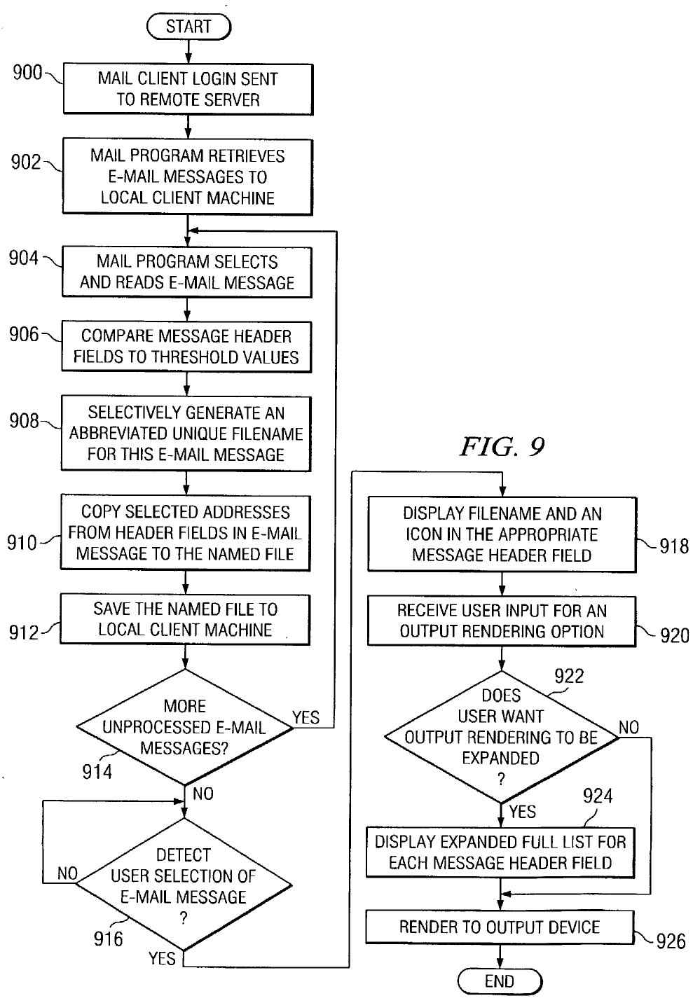

With reference now to FIG. 9, a flowchart of a process used for outputting a message is depicted in accordance with a preferred embodiment of the present invention. The process illustrated in FIG. 9 may be implemented in an e-mail program, such as message processing unit 402 in FIG. 4. This process more specifically illustrates the receipt of e-mail messages and the sending of those messages to an output device.

The process begins by sending the client login to the remote server (step 900). This server may be mail system 400 in FIG. 4 and may take the form of a POP3 server. The e-mail messages are retrieved by the e-mail program and saved to the local client machine (step 902). An unprocessed e-mail message is selected and read (step 904). The number of addresses in the message header fields is compared to the threshold values (step 906). These threshold values are values, such as those selected using window 600 in FIG. 6. An abbreviated unique filename for this message is selectively generated (step 908). A filename is generated only if the addresses exceed the threshold values set for the message header fields. When the addresses exceed these threshold values, these addresses are copied from the header fields in the e-mail message to the named file (step 910). The named file is saved to the local client machine (step 912).

A determination is made as to whether more unprocessed e-mail messages are present (step 914). The process will return to step 904 from step 914 until all of the messages have been processed. If more unprocessed e-mail messages are absent, the process then detects the user selection of an e-mail message to be sent to an output device (step 916). If the user has selected an e-mail message, the filename and an icon are displayed in the appropriate e-mail message header field (step 918). Next, a user input is received selecting an output rendering option (step 920).

Next, a determination is made as to whether the user input indicates that the output rendering is to be expanded (step 922). If the user wants output rendering to be expanded, the expanded full list for each message header field is displayed (step 924). This expanded list, may be, for example, message header field 502 as illustrated in FIG. 5A above. Thereafter, the message is rendered to the output device (step 926) and the process terminates thereafter.

Referring again to step 922, if the user does not want output rendering to be expanded, the process proceeds to step 926 as described above. In this instance, the message is printed with the abbreviated form, such as the one illustrated in FIG. 5B.

Thus, the present invention provides an improved method, apparatus, and computer instructions for handling mail message header fields. The mechanism of the present invention avoids having to present for output numerous addresses in message header fields. This mechanism is especially useful in the instance in which the output device has limited resources. For example, PDAs and digital phones have a limited viewing area and having to look through hundreds of addresses to get to the subject and text of an e-mail message is inconvenient and frustrating to users of these devices. This mechanism is also advantageous in generating hard copies of messages. The mechanism of the present invention avoids the printing of numerous pages of addresses before printing of the subject and text of a message. This mechanism is also useful with other types of devices, such as text-to-speech systems in which additional time needed for audibly presenting addresses is avoided.

These advantages are provided through the processes and mechanisms described above for abbreviating addresses in message header fields. Further, the mechanism of the present invention also allows for the generation of a distribution list that may be attached to a message. This distribution list as illustrated provides one example of an alias that helps avoid wasting output resources in a rendering device, such as paper for a printer or fax machine. Further, with this distribution list, the address information is still available to a user. When used as an attachment, the user may easily expand or open the list to see all of the addresses. This expansion also is used when the user wishes to send a response to each address in the list.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMS, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for processing an e-mail message, the method comprising:
determining whether a number of addresses in the e-mail message exceeds a threshold; and
creating a distribution list from the number of addresses if the number of addresses in the e-mail message exceeds the threshold.

2. The method of claim 1 further comprising:
commencing the creating step in response to at least one of receiving the e-mail message from a sender and initiating sending of the e-mail message.

3. The method of claim 2, wherein the creating step includes:
storing the number of addresses in a file to form a stored set of addresses for the distribution list.

4. The method of claim 1 further comprising:
attaching the distribution list to the e-mail message as an attachment.

5. The method of claim 1, wherein the number of addresses is located in a header field in the e-mail message.

6. The method of claim 1 further comprising:
responsive to a request to forward the e-mail message, attaching the distribution list to the e-mail message as a text attachment.

7. The method of claim 1, wherein the data processing system is selected from one of a computer, personal digital assistant, digital phone, or set-top device.

8. A data processing system for processing an e-mail message, the data processing system comprising:
a bus system;
a communications unit connected to the bus system;
a memory connected to the bus system, wherein the memory includes a set of instructions; and
a processing unit connected to the bus system, wherein the processing unit executes the set of instructions to determine whether a number of addresses in the e-mail message exceeds a threshold; and create a distribution list from the number of addresses if the number of addresses in the e-mail message exceeds the threshold.

9. A data processing system for processing an e-mail message, the data processing system comprising:
determining means for determining whether a number of addresses in the e-mail message exceeds a threshold; and
creating means for creating a distribution list from the number of addresses if the number of addresses in the e-mail message exceeds the threshold.

10. The data processing system of claim 9 further comprising:
commencing means for initiating the creating means in response to at least one of receiving the e-mail message from a sender and initiating sending of the e-mail message.

11. The data processing system of claim 10, wherein the creating means includes:
storing means for storing the number of addresses in a file to form a stored set of addresses for the distribution list.

12. The data processing system of claim 9 further comprising:
attaching means for attaching the distribution list to the e-mail message as an attachment.

13. The data processing system of claim 9, wherein the number of addresses is located in a header field in the e-mail message.

14. The data processing system of claim 9 further comprising:
attaching means, responsive to a request to forward the e-mail message, for attaching the distribution list to the e-mail message as a text attachment.

15. The data processing system of claim 9, wherein the data processing system is one of a computer, personal digital assistant, digital phone, or set-top device.

16. A computer program product in a computer readable medium for processing an e-mail message, the computer program product comprising:
first instructions for determining whether a number of addresses in the e-mail message exceeds a threshold; and
second instructions for creating a distribution list from the number of addresses if the number of addresses in the e-mail message exceeds the threshold.

17. The computer program product of claim 16 further comprising:
third instructions for initiating execution of the second instructions in response to at least one of receiving the e-mail message from a sender and initiating sending of the e-mail message.

18. The computer program product of claim 17, wherein the second instructions includes:
sub-instructions for storing the number of addresses in a file to form a stored set of addresses for the distribution list.

19. The computer program product of claim 16 further comprising:
third instructions for attaching the distribution list to the e-mail message as an attachment.

20. The computer program product of claim 16 further comprising:
third instructions, responsive to a request to forward the e-mail message, for attaching the distribution list to the email message as a text attachment.
